(19) United States
(12) Patent Application Publication
(10) Pub. No.: US 2022/0372948 A1
(43) Pub. Date: Nov. 24, 2022

(54) UNDERWATER WATER TRANSFER APPARATUS

(71) Applicant: Brian VON HERZEN, Minden, NV (US)

(72) Inventor: Brian VON HERZEN, Minden, NV (US)

(73) Assignee: The Climate Foundation, Seattle, WA (US)

(21) Appl. No.: 17/817,092

(22) Filed: Aug. 3, 2022

Related U.S. Application Data
(63) Continuation of application No. PCT/US2020/017253, filed on Feb. 7, 2020.

(51) Int. Cl. F03B 13/20; F03B 17/06

(52) U.S. Cl. CPC F03B 13/20; F03B 17/062; F05B 2260/02

(57) ABSTRACT

Disclosed is an underwater water transfer apparatus deployable within a water body. The apparatus includes a closed receptacle suspended underwater at a first depth, the receptacle adapted to receive ambient water at the first depth therewithin as a result of either the relative movement of the receptacle with respect to the ambient water or vice versa, or both, a tube in fluid communication with the receptacle, and a heat exchanger submerged at a second depth. The heat exchanger extends from an extremity of the tube so as to alter the temperature of the incoming water from the tube, before being released at the second depth, to be closer to that of ambient water at the second depth.

### CROSS REFERENCE TO RELATED APPLICATION

This application is a continuation of International Pat. Appl. No. PCT/US2020/017253, filed on Feb. 7, 2020, pending, incorporated herein by reference as if fully set forth herein.

### FIELD OF THE INVENTION

The present invention relates to restoration of health of large water bodies, which automatically results in improved productivity of aquatic life, mitigation of hurricanes, and the like, balancing of carbon content, and more particularly to an underwater water transfer apparatus for upwelling water from the depths of the water bodies and by doing so, achieving the aforementioned health restoration.

One of the many destructive effects of the global warming is the acidification of water bodies, mainly oceans, which is caused by the absorption of carbon emissions in the atmosphere. The oceans have absorbed about 30 percent of carbon dioxide that sent into the atmosphere since the start of the Industrial Revolution. Thirty percent of atmospheric carbon dioxide since the start of the industrial revolution easily amounts to 150 billion tons. Some recent studies even alarmingly went on to say that up to a staggering 94% of global warming today is stored in the oceans. Although these water bodies, by absorbing these harmful gases, have done a great favor to humanity in substantially slowing down global warming, this has been accomplished at a great cost to aquatic life and even to whole aquatic ecosystems.

In a recent study, it has been found out that, as a result of the acidification of the oceans, large numbers of fish and other aquatic animals are migrating to waters closer to the poles. The numbers of other forms of aquatic life are dwindling day by day as the acidic oceanic environment is not as conducive for life. Another reason for the dwindling aquatic life is an increase in the temperature of the surface and subsurface layers of the oceans (another direct result of the acidification of oceans) to an extent that these layers pose a physical energy barrier that prevents upwelling of nutrient-rich water containing macronutrients and micronutrients, which increases indigenous life productivity in the ocean. Simply put, these temperature conditions of the oceans kill the base of the food chain. An increase in surface temperature is also believed to fuel natural disasters, especially hurricanes, floods, and the like.

In light of these and other problems, there is a long-felt need for a solution such problems.

### SUMMARY

The present invention comprises an underwater water transfer apparatus for upwelling waters from depths of a water body to a level where fish and other aquatic animals generally survive. In one embodiment, the apparatus harnesses the naturally and abundantly available surface wave energy of the water body, which may be an ocean, a gulf, a bay, a lake or the like without employing any machines. The apparatus comprises a primary buoy adapted to float on the surface of the ocean, whereby the primary buoy can be subject to vertical oscillatory movement when placed in the water body (e.g., due to the movement of surface waves). The apparatus further comprises a submerged receptacle suspended from the primary buoy, whereby upward movement of the primary buoy may be imparted thereto. Notably, the upward movement of the receptacle will hereinafter be referred to as an “upstroke.” The receptacle, upon the completion of the upstroke, may descend downward (termed as a “downstroke”) due to its average density being (or when its average density is) greater than that of the ambient nutrient-rich water that surrounds it.

The receptacle may comprise top and bottom one-way valves thereon, wherein the top and bottom valves are adapted to open up so as to allow the passage of the ambient nutrient-rich water therethrough into the receptacle during the upstroke and downstroke respectively. An upwelling tube, which is in fluid communication with the receptacle, extends upwardly from the receptacle. As the receptacle receives nutrient-rich water with every upstroke and downstroke, the thus collected water within the receptacle enters the upwelling tube.

The apparatus further comprises a submerged heat exchanger extending from a top or free end of the upwelling tube so as bring the temperature of the incoming upwelled nutrient-rich water from or in the upwelling tube closer (e.g., substantially closer) to that of the ambient water. Once the nutrient-rich water is processed through the heat exchanger, it is distributed into the ambient water through a diffuser. The present invention thus endeavors to avert the aforementioned potential crisis by employing multitudes of such apparatuses within the ocean, leading to growth and development of aquatic life.

Other objects and advantages of the embodiments herein will become readily apparent from the following detailed description, taken in conjunction with the accompanying drawings.

### BRIEF DESCRIPTION OF THE DRAWINGS

FIG. 1, according to an embodiment of the present invention, is a schematic illustration of the upwelling apparatus.

FIG. 2, according to an embodiment of the present invention, is an illustration of a perspective view of the primary surface buoy.

FIG. 3, according to an embodiment of the present invention, is an illustration of a perspective view of the receptacle.

FIG. 4, according to an alternate embodiment of the present invention, is an illustration of a perspective view of the receptacle.

FIG. 5, according to another alternate embodiment of the present invention, is an illustration of a perspective view of the receptacle.

FIG. 6, according to an alternate embodiment of the present invention, is an illustration of a top view of the herringbone-structured diffuser tube.

FIGS. 7A and 7B, according to an embodiment of the present invention, are sequential illustrations of the side sectional views of the receptacle depicting nutrient-water being received therewithin during the upstroke and the downstroke respectively.

FIG. 8, according to an additional embodiment of the present invention, is an illustration of a side sectional view of the receptacle with side one-way valves.

FIGS. 9 and 10, according to an additional embodiment of the present invention, are schematic illustrations of the upwelling apparatus employing two and four upwelling tubes.

### FIGURES—REFERENCE NUMERALS

10—Underwater Water Transfer Apparatus
12—Primary Surface Buoy
14—Water Body, Ocean
16—GPS Unit
18—Receptacle
20—Top Panel
22—Bottom Panel
24—Sidewall
26T—Top One-way Valve
26B—Bottom One-way Valve
26S—Side One-way Valve
28—Pipe
30—Triangular Side Panel
32—Rectangular Side Panel
33—Cable
34—Upwelling Tube
36—Heat Exchanger
38—Diffuser
39—Secondary Surface Buoy
40—Kelp
42—Herringbone Structure
44—Nutrient-rich Water
46—Oblique Panel

### DETAILED DESCRIPTION

In the following detailed description, reference is made to the accompanying drawings that form a part hereof, and in which the specific embodiments that may be practiced are shown by way of illustration. These embodiments are described in sufficient detail to enable those skilled in the art to practice the embodiments, and it is to be understood that logical, mechanical and other changes may be made without departing from the scope of the embodiments. The following detailed description is therefore not to be taken in a limiting sense.

The present invention comprises an underwater water transfer apparatus for upwelling water from a depth of a water body ranging for example between 100 and 1000 meters. The water body may be or comprise a lake or an ocean. The upwelling activity of the apparatus is powered by either underwater currents (in the event of the water body being a lake, or the like), or surface wave energy (in the event of the water body being an ocean), or both underwater currents and surface wave energy (in the event of the water body being an ocean). The upwelled water, which is generally nutrient-rich, upon further processing, is used in harvesting kelp and plankton growth, the benefits of which are discussed in the earlier background section.

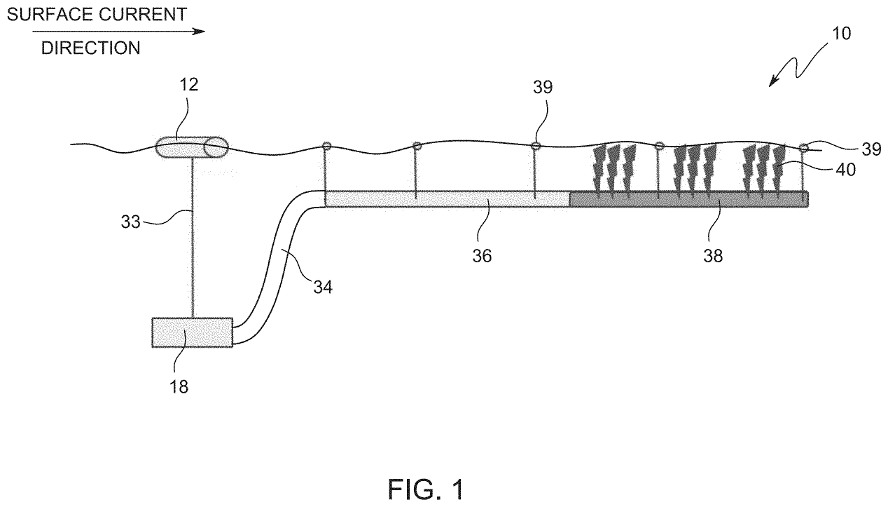

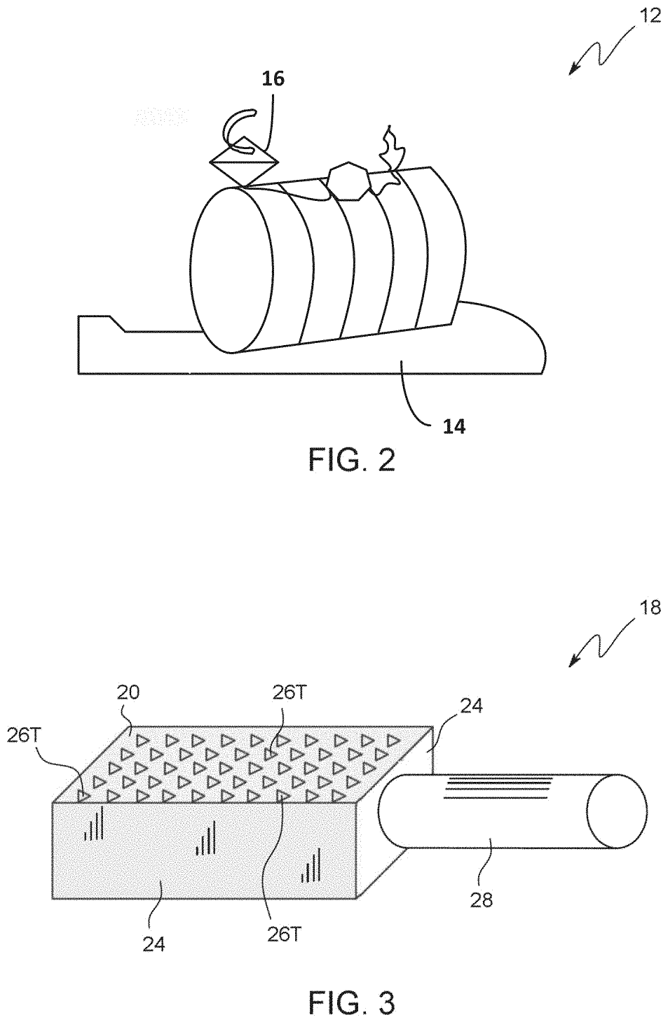

Referring to FIGS. 1 and 2, in a preferred embodiment of the present invention, the apparatus 10 comprises a primary surface buoy 12 floatable on the surface of a water body 14. The primary buoy 12 comprises or is made of a resilient buoyant material so as to withstand collisions and impacts caused by transportation vessels. The primary buoy 12 may be constantly subjected to vertical oscillatory movement due to the dynamics of the surface waves of the ocean. Notably, the magnitude of the buoyancy of the primary buoy 12 is determined based on the balance between (a) the largest and steepest waves that should be accommodated and (b) the amount of damage incurred by the apparatus 10 as a result thereof. The primary buoy 12 is fitted with a Global Positioning System (GPS) unit 16 for providing GPS and satellite uplink(s) so as to make the apparatus 10 locatable on the GPS.

Referring to FIGS. 1 and 3, the apparatus 10 further comprises a closed receptacle 18 that, in operation, is submerged within the ocean at a first depth ranging between 100 and 1000 meters, where the ambient water surrounding the receptacle 18 is nutrient-rich. The receptacle 18 comprises a rectangular structure defined by a top panel 20, a bottom panel 22, and sidewalls 24 extending between the top and bottom panels 20 and 22 so as to form a chamber therebetween. The top and bottom panels 20 and 22 comprise a plurality of top and bottom one-way valves 26T and 26B thereon or therein, wherein the one-way valves may each comprise a flapper valve, a hinge valve, or the like, that allows for unidirectional fluid passage therethrough. More particularly, as will be apparent from the following description, the top and bottom valves 26T and 26B are configured to allow the passage of nutrient-rich water into the receptacle chamber 18. One of the sidewalls 24 comprises an opening thereon or therein, and a pipe 28 that extends integrally and outwardly from the opening, wherein the utility of the opening and the pipe 28 will become apparent from the following description.

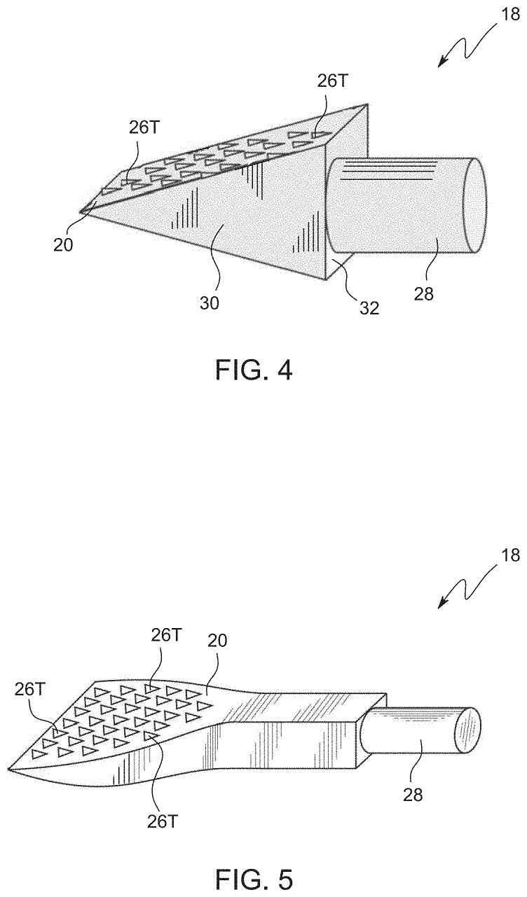

Referring to FIGS. 1, 4 and 5, in one embodiment, the receptacle 18 may comprise a wedge-shaped triangular member comprising top and bottom panels 20 and 22, both of which share a common edge, a pair of triangular side panels 30 and a rectangular panel 32 disposed opposite to the common edge. A chamber is defined between the panels for receiving nutrient-rich water therewithin. The top and bottom panels 20 and 22 comprise a plurality of top and bottom one-way valves 26T and 26B thereon or therein, wherein the one-way valves may each comprise a flapper valve or a hinge valve that allows for unidirectional fluid passage therethrough. The receptacle 18 further comprises an opening on or in the rectangular side panel 32 and a pipe 28 that extends integrally and outwardly from the opening, wherein the utility of the opening and the pipe 28 will become apparent from the following description. Alternatively, the receptacle 18 can be or comprise any closed structure, such as the one exemplarily shown in FIG. 5, as long as the utility thereof is not compromised.

Referring to FIG. 1, the apparatus 10 further comprises a flexible, inelastic cable 33 extending from the primary buoy 12, configured to support the suspension of the receptacle 18 by the primary buoy 12. The cable 33 is either made of steel, a composite material, or of polymer. As the stretch of the cable 33 is limited due to it being inelastic, the upward movement of the primary buoy 12 (from riding a surface wave) can be (and generally is) imparted to the receptacle 18, causing the receptacle 18 to move upwards. Notably, the upward movement of the receptacle 18 will hereinafter be referred to as an “upstroke.” On account of the average density of the receptacle 18 being greater than that of the ambient water surrounding it, upon the completion of the upstroke, the receptacle 18 sinks downward until the slack of the cable 33 is taken up and the downward movement ends. Notably, the downward movement of the receptacle 18 will hereinafter be referred to as a “downstroke.” Gravity maintains the tension between the receptacle 18 and the primary buoy 12.

Referring to FIG. 1, the apparatus 10 further comprises a tube 34 secured to the pipe 28 (or, alternatively, directly to the receptacle 18) and extending upwardly therefrom. Notably, the apparatus 10 is configured such that no contact occurs or is observed between the tube 34 and the cable 33 (i.e., the tube and the cable are configured to avoid contact with each other). The tube 34 comprises and may preferably be made of polyethylene, and the diameter of the tube 34 is in one example preferably 3 meters. The thickness of an extremity portion of the tube 34 that is secured to and extending from the pipe 28 is greater than the rest or remainder of the tube 34 so as to minimize the strain. There are, however, alternative geometries that are clear to those skilled in the art that will optimize strain to a greater or lesser degree.

Referring to FIG. 1, the top or free end of the tube 34 is mechanically secured to a tubular heat exchanger 36 submerged in the water body at a second depth that may range between 5 to 100 meters. The heat exchanger 36 is configured to alter the temperature of the upwelled nutrient-rich water to be closer to that of the ambient water surrounding the heat exchanger 36. The heat exchanger 36 comprises or is made of a piping material including, for example, steel or other thermally conductive metal, PVC, HDPE, LDPE or the like. The higher the thermal conductivity, the better and quicker the heat exchange. In one embodiment, an additional cable is run between the receptacle 18 and the heat exchanger 36 so as to prevent undue strain between a portion of the tube 34 where it is secured to the receptacle 18 and a portion of the tube 34 where it is secured to the heat exchanger 36. The additional cable comprises and may preferably be made of steel, a polymer, etc. The heat exchanger 36 is adapted to process the upwelled water so that the temperature difference between the upwelled, nutrient-rich water output from the heat exchanger and the ambient water is two degrees centigrade (2° C.) or less, with the temperature of the upwelled water being less that the temperature of the ambient water. Notably, the two-degree centigrade difference between the upwelled water and the ambient water may keep the upwelled water buoyant.

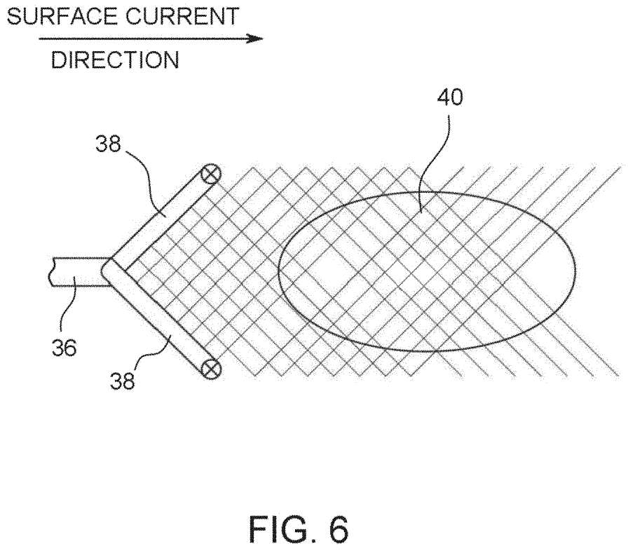

Referring to FIG. 1, the upwelled water, before being released into the ambient water, is input into a submerged diffuser 38, which comprises a tubular structure comprising a plurality of holes disposed thereon or therein. The heat exchanger 36 and the diffuser 38 may be submerged at the same second depth. The diffuser 38 may also comprise or be made of piping material including, for example, steel, PVC, HDPE, LDPE or the like. In one embodiment, as can be appreciated from FIG. 6, the apparatus 10 may employ two diffuser pipes 38, both proceeding or extending from the heat exchanger 36 in a herringbone or Y-shaped structure 42, whereby the kelp 40, by feeding on the nutrient-rich water, is grown between the two diffuser pipes 38. Notably, the two diffuser tubes 38 may lie in a same plane. Further, the heat exchanger 36 and the diffuser 38 are supported by a plurality of secondary surface buoys 39. In one embodiment, instead of the primary buoy 12, one of the secondary buoys 39 is fitted with a GPS unit 16 for providing GPS and satellite uplink(s) so as to make the apparatus 10 locatable on the GPS.

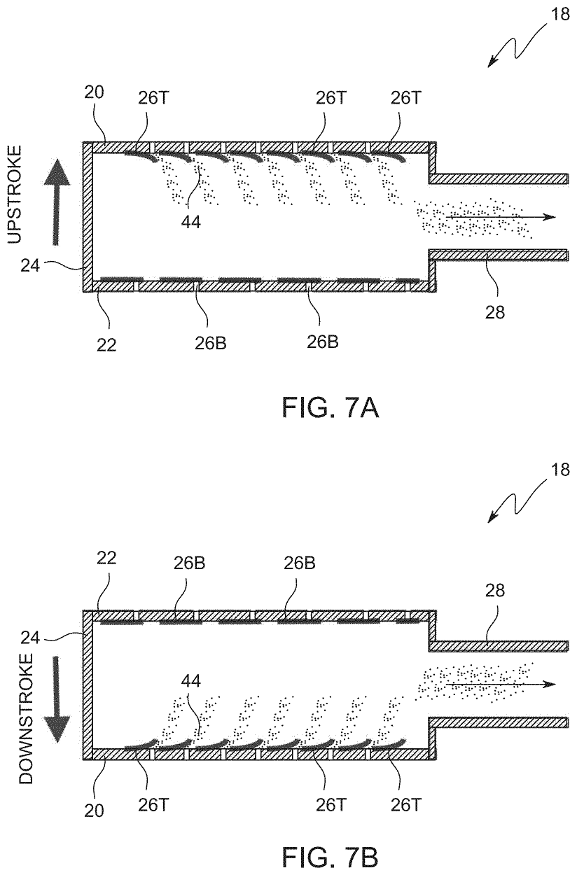

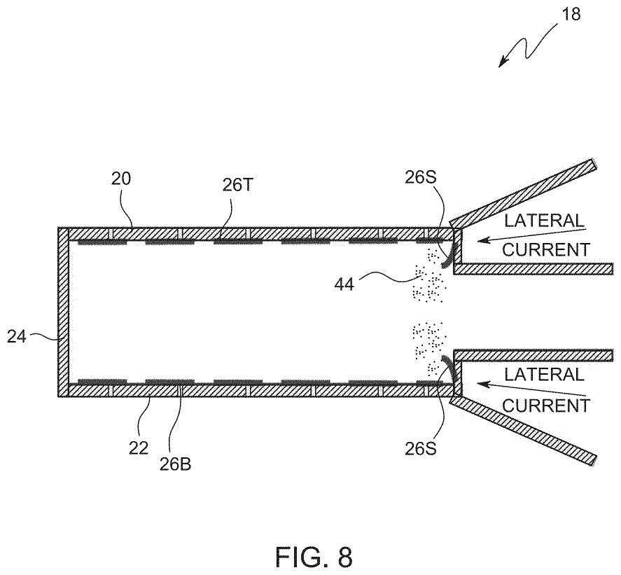

Referring to FIGS. 7A and 7B, during the upstroke of the receptacle 18, the top valves 26T open up due to the pressure being exerted thereon by the ambient water 44. As the top valves 26T are opened, the nutrient-rich water 44 enters the chamber of the receptacle 18, whereafter the nutrient-rich water 44 enters the tube 34 through the pipe 28. Notably, the nutrient-rich water 44 that entered the chamber exerts pressure on the flaps of the bottom valves 26B sealing them shut. In a similar fashion, during the downstroke of the receptacle 18, the bottom valves 26B open up due to the pressure being exerted thereon by the ambient water 44. As the bottom valves 26B are opened, the nutrient-rich water 44 enters the chamber of the receptacle 18, whereafter the nutrient-rich water 44 enters the tube 34 through the pipe 28. Notably, the nutrient-rich water 44 that entered the chamber exerts pressure on the flaps of the top valves 26T, sealing them shut. In one embodiment, as can be appreciated from FIG. 8, the receptacle 18 comprises a plurality of side one-way valves 26S that enable the nutrient rich water 44 to enter therethrough into the chamber. The side valves 26S open up due to the horizontal movement of the receptacle 18 due to drag, or the like, or due to water currents strong enough to open the side valves. Additionally, in this embodiment, the receptacle 18 may be fitted with a pair of opposingly-disposed rectangular panels 46 obliquely extending divergently from the top and bottom edges of the receptacle 18 (as shown in FIG. 8) so as to direct the nutrient-rich water 44 towards the side valves 26S. This embodiment of the receptacle 18 (with side valves 26S and oblique panels 46) is particularly employed for the embodiment of the apparatus 10 used in lakes, and the like, where upwelling is based on underwater currents.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

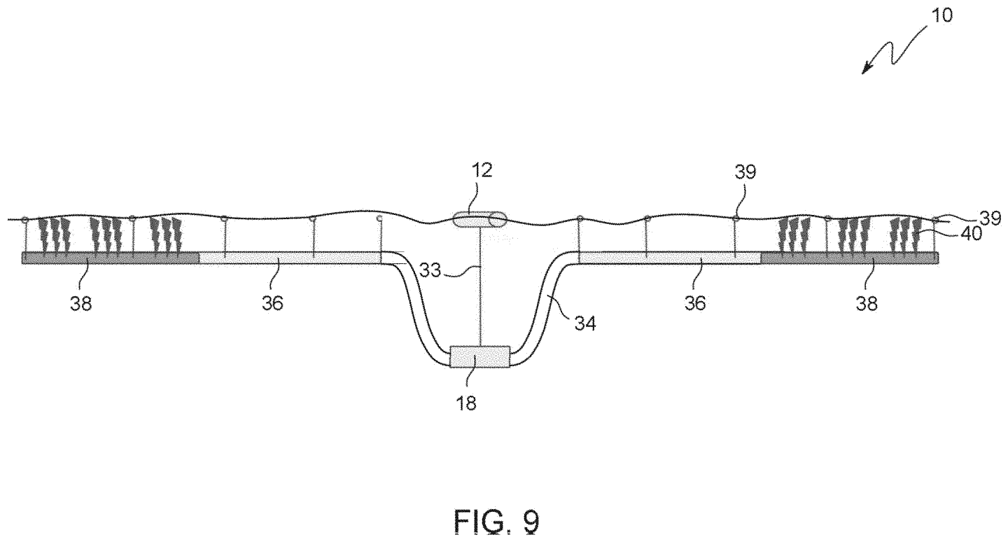

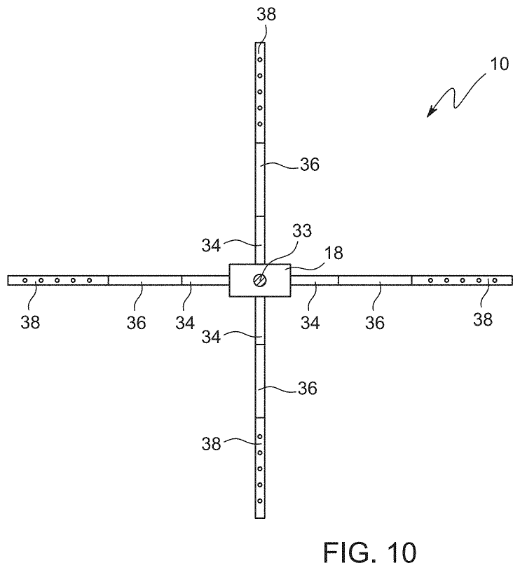

Although the embodiments herein are described with various specific embodiments, it will be obvious for a person skilled in the art to practice the invention with modifications. For example, more than one tube 34 may be disposed in fluid communication with the receptacle 18 as shown in FIGS. 9 and 10. However, all such modifications are deemed to be within the scope of the claims.

What is claimed is:

1. An underwater water transfer apparatus deployable within a water body, the apparatus comprising:
(a) a closed receptacle suspendable underwater at a first depth, the receptacle adapted to receive ambient water at the first depth therewithin as a result of either relative movement of the receptacle with respect to the ambient water or vice versa, or both;
(b) a tube in fluid communication with the receptacle; and
(c) a heat exchanger submergible at a second depth, the heat exchanger extending from an extremity of the tube so as to alter the temperature of the incoming water from the tube, before being released at the second depth, to be closer to that of ambient water at the second depth.

2. The apparatus of claim 1, further comprising a primary surface buoy adapted to float on a surface of the water body, wherein the primary surface buoy is subject to vertical oscillatory movement when placed in the water body and the water body has surface waves, and the receptacle is suspended from the primary buoy, whereby upward movement of the primary buoy causes the receptacle to rise upward; the upward movement of the receptacle is referred to as an upstroke.

3. The apparatus of claim 2, wherein water is received within the receptacle during the upstroke.

4. The apparatus of claim 2, further comprising an inelastic, flexible cable about which the receptacle is suspended from the primary buoy.

5. The apparatus of claim 2, wherein the primary buoy is locatable on a Global Positioning System (GPS).

6. The apparatus of claim 1, wherein the first depth is greater than the second depth.

7. The apparatus of claim 1, wherein the receptacle comprises a plurality of one-way valves configured to allow water to pass into the receptacle and that are sensitive to the relative movement of the receptacle.

8. The apparatus of claim 1, wherein the receptacle comprises:
(a) a top panel;
(b) a bottom panel;
(c) at least one sidewall extending between the top and bottom panels so as to form a receptacle chamber therebetween, the at least one tube extending from the at least one sidewall; and
(d) a plurality of one-way valves on at least one of the top and bottom panels and the at least one sidewall.

9. The apparatus of claim 1, wherein the water body comprises an ocean or a lake.

10. The apparatus of claim 1, further comprising at least one secondary buoy from which the heat exchanger is suspended.

11. The apparatus of claim 1, wherein the tube comprises a first portion that engages the receptacle and a second portion that engages the heat exchanger, each of the first portion and the second portion having a thickness greater than that of a remainder of the tube.

12. The apparatus of claim 1, wherein the first depth ranges between 100 and 1000 meters.

13. The apparatus of claim 1, wherein the at least one tube comprises polyethylene.

14. The apparatus of claim 1, wherein the heat exchanger comprises tubular polyethylene.

15. The apparatus of claim 1, further comprising a submerged diffuser extending from an output extremity of the heat exchanger, the diffuser comprising a plurality of holes configured to diffuse the water therethrough.

16. The apparatus of claim 1, wherein the second depth ranges between 5 and 100 meters.

17. The apparatus of claim 1, further comprising an additional cable extending between the heat exchanger and the receptacle configured to withstand strain that would otherwise be borne by the tube.

18. The apparatus of claim 1, wherein the at least one tube comprises a plurality of tubes.

19. An underwater water transfer apparatus comprising:
(a) a primary buoy configured to float on a surface of a water body, causing the primary buoy to oscillate vertically due to surface waves of the water body;
(b) a submerged, closed receptacle suspended from the primary buoy, whereby upward movement of the primary buoy is imparted to the receptacle, while downward movement of the receptacle is caused by the average density thereof when the average density of the receptacle is greater than that of the ambient water surrounding the receptacle, the receptacle being configured to receive ambient water therewithin either during an upstroke thereof or a downstroke thereof, or during both, the upstroke and the downstroke comprising the upward movement and the downward movement of the receptacle respectively;
(c) a tube in fluid communication with the receptacle, configured such that the water received within the receptacle is driven thereinto; and
(d) a submerged heat exchanger extending from a top end of the tube so as to bring a temperature of the water from or in the tube closer to that of the ambient water before being released into the ambient water.

20. The apparatus of claim 19, wherein when the apparatus in placed in the water body, a depth at which the receptacle is submerged is greater than a depth at which the heat exchanger is submerged.
